(19) United States
(12) Patent Application Publication
(10) Pub. No.: US 2003/0147459 A1
(43) Pub. Date: Aug. 7, 2003

(54) Interface concept for the exchange of digital signals between an rf ic and a baseband ic

(76) Inventor: Roland Egon Ryter, Birmensdorf (CH)

Correspondence Address: PHILIPS ELECTRONICS NORTH AMERICAN CORP, 580 WHITE PLAINS RD, TARRYTOWN, NY, 10591, US

(21) Appl. No.: 10/258,046

(22) PCT Filed: Mar. 15, 2002
(86) PCT No.: PCT/IB02/00799

(30) Foreign Application Priority Data
Mar. 17, 2001 (EP) 01106757.6

(51) Int. Cl. H04B 1/38

(52) U.S. Cl. 375/219

(57) ABSTRACT

The invention relates to a circuit arrangement which is provided with an analog receive and transmit unit which includes at least one A/D converter 13 and at least one D/A converter 14 for the conversion of signals, and also with a digital processing unit for the processing of digital signals. The invention also relates to a user set for mobile communication which includes a circuit arrangement of this kind and to a method for the transmission of digital signals between an analog receive and transmit unit and a digital processing unit. A circuit arrangement is proposed in which a reliable transmission of digital signals between a digital processing unit and an analog receive and transmit unit can be realized with little effort; to this end, it is proposed to provide a storage unit 17 and an interface 18, 19 which are arranged for the exchange of digital signals between the analog receive and transmit unit and the digital processing unit, the signal or data exchange between the receive and transmit unit and the digital processing unit taking place exclusively in the transmit and receive gaps 43.

The invention relates to a circuit arrangement which is provided with an analog receive and transmit unit which includes at least one A/D converter and at least one D/A converter for the conversion of signals, and also with a digital processing unit for the processing of digital signals. The invention also relates to a user set for mobile communication which includes a circuit arrangement of this kind and to a method for the transmission of digital signals between an analog receive and transmit unit and a digital processing unit.

Circuit arrangements of this kind are used in communication systems, for example, in a TDMA system (for example, a GSM system).

The continuously increasing integration density of components in portable electronic apparatus leads to an ever smaller number of circuit arrangements, ultimately leading to lower costs, smaller apparatus and a greater availability. A chip set for a mobile telephone can thus be reduced to a few chips. The circuit arrangements required include, for example, a unit in which the receive and transmit units are accommodated, a digital processing unit and input and output units.

The processing of the signals takes place on a digital basis to a high degree. The reception and the transmission of data or signals, however, are both analog. For the processing of the analog circuits there is provided a circuit arrangement with a receive and transmit unit which will also be referred to as the RF IC (RF radio frequency).

For the further processing of the received analog signals, these signals are subjected to an A/D conversion so as to be converted into digital signals. After this conversion, the processing of the signals is exclusively digital; the signals being converted into analog signals again for output, for example output of the audio signals via the loudspeaker. Similarly, signals or data to be transmitted are subjected to a D/A conversion so as to be transmitted in analog form.

The components for the processing of analog and digital signals differ very significantly. All analog functions, for example, mixers and filters, can in principle be digitally realized. However, it is a very intricate operation to realize functions of this kind with a comparable speed and resolution. The analog components envisaged are mainly frequency mixers, amplifiers or filters whereas the digital processing utilizes digital signal processors and system controllers. The digital signal processor also comprises filter functions, but an implementation of an RF filter in digital form would be much too slow or its current consumption would be much too high.

The signals received may have a very low level; the levels are typically from −102 dBm to −12 dBm so that they may be very susceptible to superpositions and disturbances.

According to solutions known thus far there is provided a circuit arrangement in which exclusively the conversion of the signals into one form or the other is performed by means of A/D and D/A converters. This circuit arrangement is supplied with analog signals for conversion; at the same time signals are also supplied in digital form so as to be converted into analog signals. The circuit arrangement outputs the digitized signals, via an interface, to the digital processing unit. Similarly, the signals presented by the digital processing unit are applied to the D/A converter of said circuit arrangement via the interface.

This solution has the drawback that it requires an additional circuit arrangement which occupies a corresponding amount of space in the electrical apparatus.

The components of the circuit arrangement in a further embodiment are integrated on the RF IC provided with the interface unit with the relevant A/D and D/A converters and a corresponding interface. Severe requirements must then be imposed on the interface, because it should be capable of transmitting the digital data at a high data rate to the circuit arrangement with the digital processing unit. Such a circuit arrangement with the digital processing unit will also be referred to as the baseband IC hereinafter.

This system has the drawback that digital and very sensitive analog signals are simultaneously active on the RF-IC. For example, the input signal from the antenna of a mobile telephone may have a very low level and VCO (voltage-controlled oscillator) signals in the RF IC are also very susceptible to interference. The transmission of digital signals via the interface simultaneously with the processing of analog signals may give rise to a severe disturbance of said analog signals. In order to reduce such superposition effects, it is necessary to ensure that the interface has the appropriate properties. For example, the digital signals should have as long as possible rise times in the digital edges, so that the spectrum of the RF components is reduced; a small signal swing is also advantageous. These properties are realized by means of additional components which are required for the RF IC as well as for the baseband IC.

According to this concept it is advantageous that only two circuit arrangements are required. It is a drawback of this concept that the interface between the RF IC and the baseband IC must be constructed in such a manner that the superposition and disturbing of the sensitive analog signals is precluded and that the interface must be especially constructed in conformity therewith. To this end, as described above, analog units are required for the reduction of the edge steepness of the digital signals by means of analog filters which themselves increase the effort required to adapt the components of the baseband IC or the RF IC to new process technologies.

A further problem is encountered when novel process technologies with ever narrower conductor tracks, smaller distances between the conductor tracks and also reduced breakdown voltages of the transistors are used. The usable voltage range is thus reduced, so that the implementation of corresponding analog functions becomes more difficult or even impossible.

Therefore, it is an object of the invention to provide a circuit arrangement in which a reliable transmission of digital signals between a digital processing unit and an analog receive and transmit unit can be realized with little effort.

This object is achieved by means of a circuit arrangement which is provided with an analog receive and transmit unit which includes at least one A/D converter and at least one D/A converter for the conversion of signals, with a digital processing unit for processing digital signals, with at least one storage unit and also with an interface, which elements are arranged for the exchange of digital data between the analog receive and transmit unit and the digital processing unit.

The circuit arrangement includes an analog receive and transmit unit which is arranged to receive analog signals and on the other hand to transmit analog signals to, for example, base stations or to mobile user sets. This analog receive and transmit unit includes inter alia at least one A/D converter which converts the received analog signals into digital signals after their conversion into I and Q signal components in the receive unit. Also provided is a D/A converter which converts the signals presented by the digital processing unit into analog signals which themselves are transmitted via the antenna.

The analog receive and transmit unit includes appropriate amplifiers which amplify a signal of very low level, received from the antenna, to a corresponding signal level. Similarly, this analog receive and transmit unit includes filters for suppressing, in the signal received, interference or signal components from neighboring channels of other mobile radio users or signals of high levels in other frequency bands, for example, from radio stations. The analog receive and transmit unit is provided with mixer units whereby a signal is set from one carrier frequency to another carrier frequency.

The digital processing unit is provided with a digital signal processor and a system controller which are arranged to process the digital data, for example, demodulation and equalization, to encode or decode speech and to control the display driver.

In accordance with the invention it is proposed to integrate a storage unit, in which the digital signals are buffered, in the analog receive and transmit unit. This storage unit is connected to an interface which is arranged to exchange digital signals, stored in the storage unit, between the analog receive and transmit unit and the digital processing unit. As a result of such buffering, the digital signals can be transmitted between the analog receive and transmit unit and the digital processing unit at instants at which the influencing of the sensitive analog signals is low. Consequently, the interface may have a simpler construction.

In an advantageous embodiment of the invention, the analog receive and transmit unit is arranged in a circuit which is also referred to as an RF IC. The digital processing unit is arranged in a further circuit which is referred to as a baseband IC. The individual circuit arrangements can thus be made suitable for novel process technologies without it being necessary to integrate complex analog components. Moreover, no additional circuit is required for the conversion and transmission; such a circuit would require additional space and current.

In an advantageous embodiment of the invention the storage unit and a first interface unit are arranged on the RF IC. The storage unit is then connected between the A/D and D/A converters and the first interface unit. The storage unit stores the received signals which are converted into digital signals in the A/D converter. At the same time the digital signals supplied by the baseband IC are also stored in order to be converted into analog signals in the D/A converter at a corresponding instant so as to be transmitted via the antenna.

The baseband-RF interface for the exchange of the digital signals between the analog receive and transmit unit and the digital processing unit includes a first interface unit and a second interface unit. The first interface unit is accommodated on the RF IC provided with the analog receive and transmit unit and the second interface unit is accommodated on the baseband IC with the digital processing unit. The data is serially exchanged between the ICs. Data received in the first interface unit is converted into a serial data stream so as to be serially transmitted to the second interface unit which outputs the data in parallel again. Data to be transmitted is applied in parallel to the second interface unit in which it is converted into a serial data stream so as to be serially transmitted to the first interface unit and output in parallel to the storage unit. The serial data transmission offers the advantage that the number of links required between the interface units is minimum.

In the case of applications where enough space is available on the ICs, direct parallel transmission of the data can be realized between the RF IC and the baseband IC.

In accordance with the invention it is proposed to carry out a transmission of digital signals between the digital processing unit and the analog receive and transmit unit only if no transmission or reception of analog signals is to take place.

The storage unit stores the digitized I and Q signals which are applied to the digital processing unit via the first and the second interface unit, that is, in the transmit and receive gaps. Similarly, digital signals presented by the digital processing unit are transmitted via the first and the second interface unit, to the storage unit so as to be converted (by the corresponding D/A converter) into analog I and Q signals only when a transmission burst is to take place again, these signals then being applied to the antenna.

Because in the time multiplex transmission method (for example, TDMA systems according to the GSM standard) usually only one-eighth of a time slot is available for the transmission or reception of a receive or transmit burst, enough time remains for the baseband RF interface to transmit corresponding data between the baseband IC and the RF IC in digital form. This allows for a significantly simpler interface which consists exclusively of digital components which are active whenever there are no transmit or receive activities of the RF IC. Influencing of the analog signals by superposition of digital signals is thus no longer possible.

In an alternative embodiment of the invention the storage unit is constructed so as to be subdivided in two parts. One part of the storage unit is then intended for the data of the receive path (RX) and the other part of the storage unit is intended for the data of the transmit path (TX).

The object is also achieved by means of a user set for mobile communication which includes a circuit arrangement with an analog receive and transmit unit which includes at least one A/D converter and at least one D/A converter for the conversion of signals, a digital processing unit for the processing of digital signals, at least one storage unit and an interface, which elements are arranged for the exchange of digital signals between the analog receive and transmit unit and the digital processing unit.

The object is also achieved by means of a method for the transmission of digital signals between an analog receive and transmit unit and a digital processing unit, in which method the signals are buffered in a storage unit for the exchange of signals between the analog receive and transmit unit and the digital processing unit.

An architecture of this kind can be used for GSM, DECT or Bluetooth transmission systems.

A significant advantage of this concept resides in the separation of mix signals (analog and digital signals) and digital functions on the ICs. As a result, only digital function units are integrated on the baseband IC, offering the advantage of faster and easier adaptation in the case of novel process technologies.

An embodiment of the invention will be described in detail hereinafter, by way of example, with reference to the drawing. Therein:

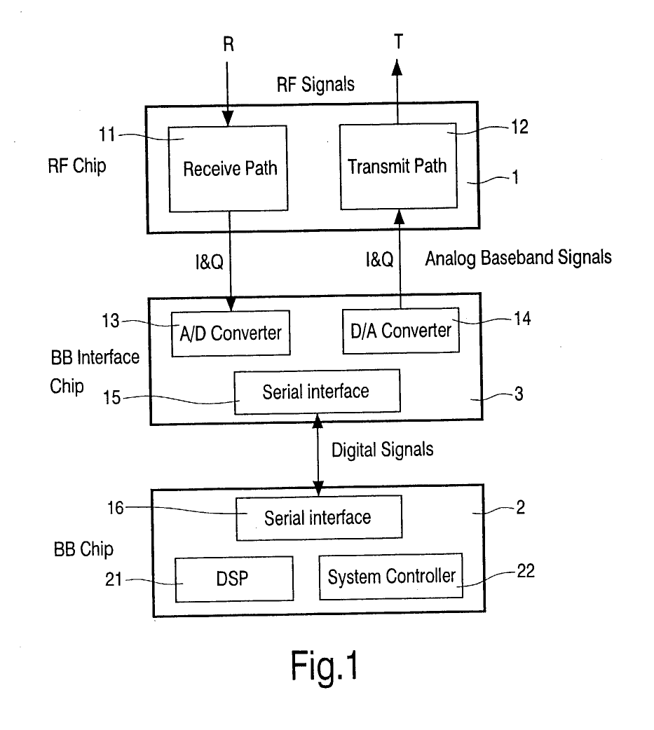

FIG. 1 shows an arrangement in conformity with the present state of the art.

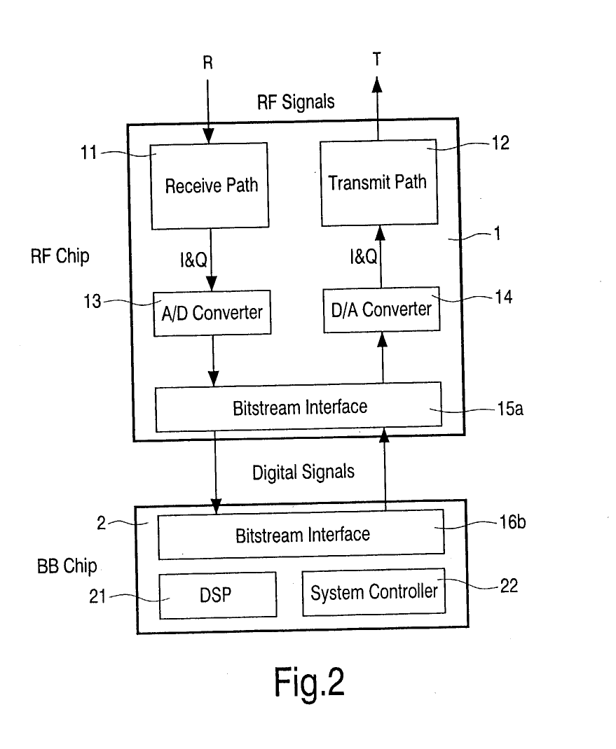

FIG. 2 shows an arrangement in which the A/ID and D/A converters and the interface are integrated on the RF IC,

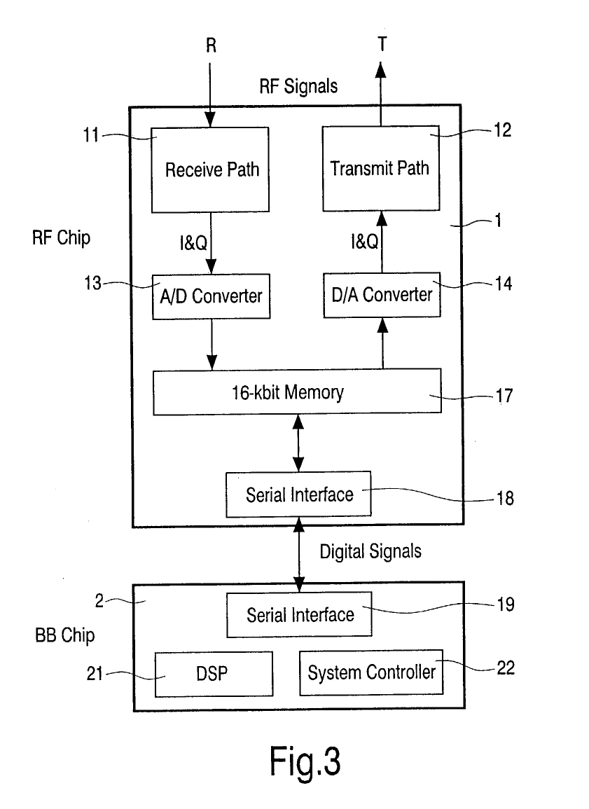

FIG. 3 shows a circuit arrangement in accordance with the invention with a memory on the RF IC,

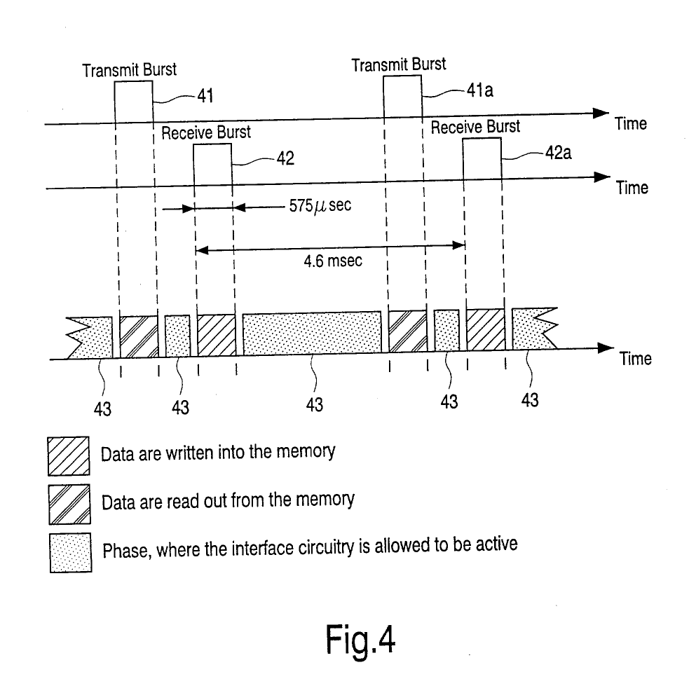

FIG. 4 shows a time diagram, and

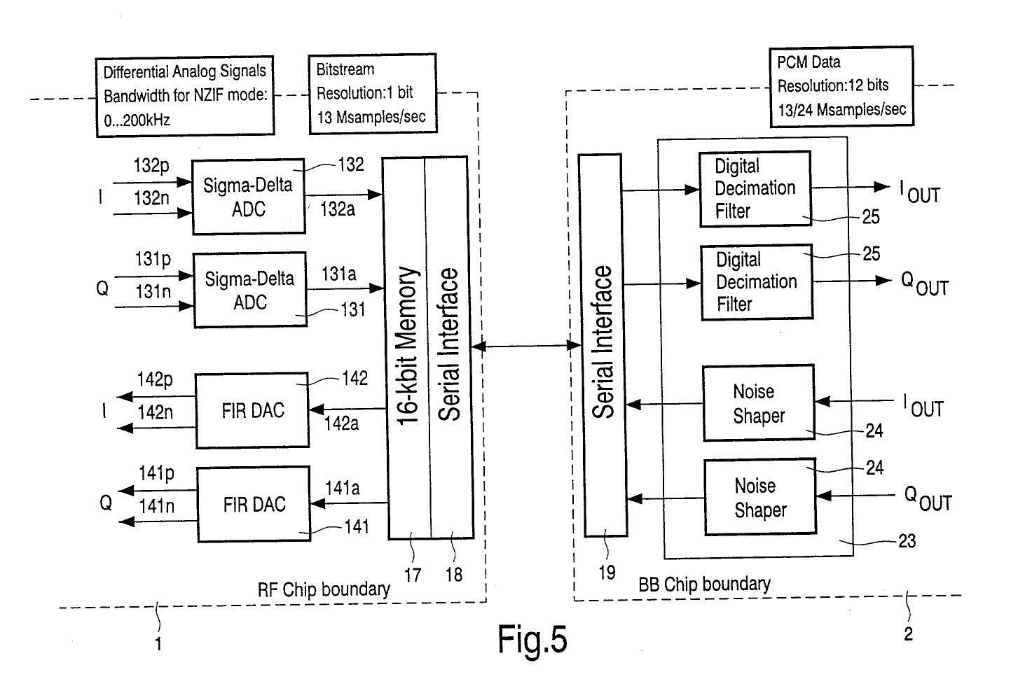

FIG. 5 is a detailed representation of the interface architecture of the arrangement in accordance with the invention.

FIG. 1 shows an arrangement in conformity with the present state of the art which is provided with three individual circuit arrangements. The RF IC 1 includes the analog receive and transmit unit and receives an analog signal R and transmits an analog signal T via an antenna which is not shown.

The receive unit 11 is provided with appropriate amplifiers, filters and mixer units for suitably increasing the level of the analog signal R received from the antenna and for removing disturbances and signal components from neighboring channels therefrom. The receive unit 11 applies a signal in the form of I and Q components to an A/D converter 13 which is arranged on an interface chip 3. The analog I and Q signal components are converted into digital signals therein. Subsequently, the digital signals are applied, via a first interface unit 15, to a second interface unit 16. The second interface unit 16 is accommodated on a baseband IC 2 which includes the digital processing unit. The baseband IC 2 accommodates a digital signal processor 21 and the system controller 22.

Because in such apparatus not only signals R are received but signals T are also transmitted to other systems, digitally encoded signals are transmitted by the digital signal processor 21 or the system controller 22, via the interface unit 16, from the baseband IC 2 with the digital processing unit, to the interface chip 3 with the interface unit 15. Subsequently, the digital signals are applied to a D/A converter 14 which converts the digital signals into corresponding analog signals in the form of I and Q components. Such I and Q signals are applied from the interface chip 3 to the RF IC 1; subsequently they are adjusted to the appropriate level in the transmit unit 12 and also to the desired carrier frequency necessary for transmission via the antenna.

The above circuit arrangement in accordance with the present state of the art includes three circuits; it is a drawback that each circuit must be arranged on the printed circuit board and connected to the other circuits, so that a corresponding amount of space is taken in on the limited surface of a printed circuit board.

In order to avoid such drawbacks, an arrangement is proposed in which the interface which is situated on the interface chip 3 in FIG. 1 is arranged, together with the corresponding A/D and D/A converters 13 and 14 and the first interface unit 15, on the RF IC 1 with the analog receive and transmit unit. This results in the arrangement shown in FIG. 2 in which practically the same components are provided as in FIG. 1, be it with the difference that in this case instead of serial first and second interface units use is made of bit stream interface units 15a and 16a which are provided on a respective one of the two chips 1 and 2. Such a bit stream interface produces a bit stream with a data rate which is much higher than the bandwidth of the input signal. A decimation filter (digital filter) which eliminates the high frequency quantization noise is not shown.

This arrangement has the drawback of the presence of digital signals with a high data rate. Because the signal contains a large quantization noise component, more bits must be transmitted than actually necessary for the actual useful signal. Consequently, it may occur that the analog signals received, for example, from the antenna, are disturbed by the transmission of digital full swing signals with high data rates and steep edges from the baseband IC 2 to the RF IC 1. In order to reduce or preclude such superposition or disturbances, an elaborate bit stream interface with the sections 15a and 16a is required, such an interface being provided with appropriate filters (not shown) which prevent influencing of the sensitive analog signals. Such filters influence inter alia the rise times in the digital edges, so that the RF components in the spectrum of the signal are reduced. To this end, for example, analog low-pass filtering is applied. The signal is also influenced so as to realize lower signal amplitudes.

FIG. 3 shows the circuit concept in accordance with the invention which involves only two circuits, the analog receive and transmit unit being accommodated on the RF-IC 1 whereas the digital signal processor 21 and the system controller 22 are arranged as the digital processing unit on the baseband IC 2. The analog receive and transmit unit receives analog signals R from the antenna; these signals are suitably amplified and filtered in the receive unit 11 so as to be applied as I and Q signals to an A/D converter 13 for digital conversion. The digitized I and Q signals are buffered in the storage unit 17.

During the intervals in which the analog receive and transmit unit does not transmit or receive signals, the signals or data stored in the storage unit 17 are applied, via the first serial interface unit 18, to the second serial interface unit 19 in the baseband IC 2.

Digital signals presented by the baseband IC 2 are applied from the second serial interface unit 19 to the RF IC 1 in which they reach the serial interface unit 18 so as to be applied to the storage unit 17 in which they are buffered. This transmission from the digital processing unit to the analog receive and transmit unit again takes place exclusively during the periods in which the circuit arrangement does not receive or transmit signals.

The data to be transmitted is converted into analog I and Q signals by the D/A converter 14 so as to be adjusted to the correct level in the transmit unit 12, after which they are transmitted as analog signals T via the antenna.

As an alternative for the arrangement shown in FIG. 3, the RF IC I may also be provided with a second storage unit (not shown) so that the memories for the receive path and the transmit path are separated.

FIG. 4 shows a time diagram. The bars 41 and 41a therein represent respective transmit bursts and the bars 42 and 42a represent respective receive bursts. In the periods between these bursts 41, 42 and 41 and 42a, in this case denoted by the reference numeral 43, the digital signals are transmitted between the baseband IC 2 and the RF IC 1.

FIG. 5 is a detailed representation of an example of the circuit arrangement in accordance with the invention. Therein, only the part of the transmit and receive unit which comprises the A/D and D/A converters, the storage unit 17 and the serial interface 18, 19 is shown. Also shown is the second serial interface unit 19 and a corresponding filter unit 23 of the baseband IC 2.

The analog signals received in the form of I and Q components are applied, via the leads 132p, 132n and 131p, 131n, to a respective sigma-delta A/D converter 132, 131. The signals 131p and 132p contain each time the positive component of the I signal or the Q signal and the signals 131n and 132n contain each time the negative component of the I signal or the Q signal. The sigma-delta A/D converters 131 and 132 convert the analog I and Q signals into a respective digital signal 131a and 132a, said signals being applied to the storage unit 17 and subsequently transmitted further via the first serial interface unit 18. A sigma-delta AID converter produces a bit stream signal from an analog input signal.

Digital signals to be transmitted are stored in the memory 17 and converted, via FIRDAC converters 141, 142, into an analog signal with I and Q signal components. 141p and 142p represent each time the positive component and 141n and 142n represent each time the negative component of the I signal and the Q signal, respectively. A FIRDAC converter (Finite Impulse Response Digital-to-Analog Converter) produces an analog signal from a bit stream signal. During this operation the RF quantization noise component is filtered out at the same time.

The baseband IC 2 includes a filter unit 23 which comprises noise shaper units 24 and digital decimation filters 25, each of which serves for the processing of incoming or outgoing digital signals.

The noise shaper has a function which is the inverse of that of the decimation filter. A digital signal with a bus width of 12 bits and a data rate of 13/24 million sample values per second (=541,700 sample values per second) is converted into a bit stream signal (13 million bits per second) which also contains a correspondingly large amount of RF quantization noise.

The bandwidth of the supplied I and Q signals and the outgoing I and Q signals amounts to from zero to 200 kHz in the NZIF (Near Zero Intermediate Frequency) mode. The data transmitted in the signals 132a, 131a by the A/D and D/A converters and signals 141a and 142a, originating from the memory 17, have a resolution of 1 bit, it being possible to transmit 13 megasamples per second.

The digitized baseband signal occurs in the baseband IC 2 as PCM (Pulse Code Modulated) data with a resolution of 12 bits, so that 13/24 megasamples are transmitted per second. Using digital filters, mixers and adaptations to suitable levels, a reduction of the data rate and resolution is to take place in the receive path. The lower the resolution and the data rate, the less computational effort will be required, thus enabling also a lower power consumption.

The invention can be used in any TDMA system in which signals are transmitted and received in bursts. In addition to the GSM systems, the present invention can also be used in an IS 54 and in an IS 136 system as used in the United States of America. Furthermore, it can be used in a DCS-1800 as used in Great Britain but also in a WACS-PACS system as used in the United States of America and in a Handy/Phone system as used in Japan. It is also suitable for use in the DECT system used in Europe.

The capacity of the storage unit is dependent on the burst widths and the oversampling ratio of the sigma-delta converters. The storage capacity of 16 kilobits which suffices for the GSM system should be enlarged accordingly for a GPRS system.

The interface is inactive while the digital signals of the storage unit 17 are converted into analog signals in the D/A converters 142, 141, which analog signals again have IF or RF frequencies. The interface is also inactive while the analog receive and transmit unit receives antenna signals which are mixed down to near zero IF signals The data can be transferred from the memory 17, via the interface, to the baseband IC 2 at the instant at which a receive burst was terminated.

FIG. 4 shows a transmit and receive burst with approximately 575 μs, for example, for a GSM system. When use is made of an oversampling frequency of 13 MHz (oversampling factor of 32.5) in the sigma-delta converters, bit stream signals having a corresponding bit rate are produced. The number of bits output from the sigma-delta converters for a burst can be calculated as follows:

575×10⁻⁶—13×10⁶=7475

Because two channels (I and Q) must be simultaneously converted in the sigma-delta converters, the number of bits calculated here must be doubled, so that a memory capacity of only 16 kilobits is required.

Because a plurality of transmit and receive bursts is transmitted and received in one time slot in the GPRS system, the storage capacity must be increased. It is an advantage of the present circuit arrangement that the EMC requirements to be satisfied are not severe, so that a simple digital interface can be implemented without it being necessary to implement complex analog filters and small-swing signal generation in the interface, which steps would require additional space and current.

1. A circuit arrangement which is provided with an analog receive and transmit unit which includes at least one A/D converter (13) and at least one D/A converter (14) for the conversion of signals, with a digital processing unit for the processing of digital signals, with at least one storage unit (17) and also with an interface (18, 19), which elements are arranged for the exchange of digital signals between the analog receive and transmit unit and the digital processing unit.

2. A circuit arrangement as claimed in claim 1, characterized in that the analog receive and transmit unit and the digital processing unit are arranged in a respective circuit.

3. A circuit arrangement as claimed in claim 1, characterized in that the storage unit (17) is arranged in the circuit (1) with the analog receive and transmit unit.

4. A circuit arrangement as claimed in claim 1, characterized in that the storage unit (17) is arranged between the A/D (13) and D/A (14) converters and a first interface unit (18).

5. A circuit arrangement as claimed in claim 1, characterized in that the digital processing unit includes a second interface unit (19) for the transmission of digital signals to the first interface unit (18).

6. A circuit arrangement as claimed in claim 1, characterized in that it is arranged to exchange digital signals between the analog receive and transmit unit and the digital processing unit in the transmission and reception gaps (43).

7. A circuit arrangement as claimed in claim 1, characterized in that the storage unit includes at least two storage sections.

8. A user set for mobile communication which includes a circuit arrangement with an analog receive and transmit unit which includes at least one A/D converter and at least one D/A converter for the conversion of signals, a digital processing unit for the processing of digital signals, at least one storage unit and one interface, which elements are arranged for the exchange of digital signals between the analog receive and transmit unit and the digital processing unit.

9. A method of transmitting digital signals between an analog receive unit and a digital processing unit, in which method the signals are buffered in the storage unit upon the exchange of signals between the analog receive and transmit unit and the processing unit.

10. A method as claimed in claim 9, characterized in that the signals are exchanged in the transmit and receive gaps.
